(19) United States
(12) Patent Application Publication
(10) Pub. No.: US 2011/0078468 A1
(43) Pub. Date: Mar. 31, 2011

(54) POWER CONTROLLER, ELECTRONIC APPARATUS AND POWER CONTROL METHOD

(75) Inventor: Katsuya OHNO, Kokubunji-shi (JP)

(73) Assignee: KABUSHIKI KAISHA TOSHIBA, Tokyo (JP)

(21) Appl. No.: 12/892,833

(22) Filed: Sep. 28, 2010

(30) Foreign Application Priority Data
Sep. 28, 2009 (JP) 2009-221982

(51) Int. Cl. G06F 1/32

(52) U.S. Cl. 713/310

(57) ABSTRACT

According to one embodiment, a power controller for controlling a power supply, includes: a receiver configured to receive a signal for switching an ON/OFF state of the power supply, a controller configured to control the ON/OFF state of the power supply, and an determining module configured to determine whether the signal is a signal for switching the power supply from the OFF state to the ON state or from the ON state to the OFF state. The controller controls to turn off the power supply, when the determining module determines that the signal is the signal for switching the power supply from the ON state to the OFF state. Further, the receiver, the controller and the determining module operate by a rechargeable battery, while the power supply is in an ON state, when the power supply is in an OFF state.

### CROSS-REFERENCE TO RELATED APPLICATION

This application is based on and claims priority under U.S.C. §119 from Japanese Patent Application No. 2009-221982 filed on Sep. 28, 2009.

### BACKGROUND

1. Field

One embodiment of the invention relates to a power controller, an electronic apparatus and a power control method for controlling to turn on/off the power supply.

2. Description of the Related Art

Generally speaking, an electronic apparatus, such as a television receiver or an HDD recorder, has, as the states thereof, an ON state in which almost all the functional modules thereof can operate and a standby state in which almost all the functional modules do not operate but only specific functions, such as starting in response to a control signal from a remote controller and time keeping, operate. Furthermore, such an electronic apparatus also has an OFF state in which the function of starting with a remote controller does not operate but only more limited functions, such as time keeping, operate, particularly as in the case of a television receiver. Electronic apparatuses having these three states and being capable of transiting among these three states are in widespread use.

Moreover, in recent years, it is expected to reduce the power consumption (also referred to as standby power) of an electronic apparatus in the standby state and the OFF state thereof, and various inventions and devices for fulfilling this expectation have been provided.

For example, Japanese Patent No. 3228542 (FIG. 1, paragraph 0015) discloses a method in which a control circuit, which is connected to an external power source disposed outside an apparatus, such as a household outlet, and to which power is supplied without passing through a switch from a power feeding circuit being energized at all times, controls the switching operation of the switch depending on power ON/OFF command signals from a remote controller, and this control circuit controls to open the switch to turn off the power supplied via the switch, thereby suppressing power consumption in the standby state.

In addition, Japanese Patent Application Publication No. Hei 07-095496 (FIG. 1, paragraph 0027) discloses a method in which, when the main power supply circuit of an apparatus is OFF, power generated mainly from a solar battery is supplied to a microcomputer for monitoring the state of the main power switch, thereby reducing the power consumption of the AC power line of the electronic apparatus to zero, and this microcomputer controls an ON/OFF state of AC power to be supplied to the main power supply circuit of the apparatus depending on the state of the main power switch.

However, according to Japanese Patent No. 3228542, in order that the control circuit incapable of detecting the switching state of the switch determines that a command signal from the remote controller is a power ON signal, the power ON signal is required to be a unique signal. In the case of a general-purpose remote controller, since the power ON signal and the power OFF signal transmitted therefrom are identical, it is difficult to implement this aim by using such a general-purpose remote controller. Furthermore, the control circuit for controlling to open/close the switch is configured so that power is supplied without passing through the switch to the control circuit from the power feeding circuit that is connected to the external power source disposed outside the apparatus, such as a household outlet, and energized at all times. Hence, it is difficult to steadily reduce the power consumption of the apparatus by using the control circuit that operates on the external power source disposed outside the apparatus, such as a household outlet, to control to open/close the switch.

Moreover, according to Japanese Patent Application Publication No. Hei 07-095496, when the main power switch is OFF, power is supplied to the microcomputer from the solar battery. In addition, when the main power switch is not OFF, power is supplied to the microcomputer from a standby transformer and a regulator. In other words, for the purpose of operating the microcomputer, it is necessary to use the solar battery and a configuration having a plurality of power supply components, such as the standby transformer and the regulator. Still further, while the main power switch is ON, when the main power switch is controlled so as to be turned off with a remote controller, the main power supply circuit is turned off, but power is supplied to the microcomputer itself from the standby transformer and the regulator. For this reason, it is difficult to reduce the standby power of the apparatus in the so-called standby state thereof.

That is to say, conventionally, it has been impossible to reduce standby power using a simple configuration.

Accordingly, in order to solve the above-mentioned problems, the present invention is intended to provide a power controller, an electronic apparatus and a power control method capable of reducing standby power using a simple configuration.

### BRIEF DESCRIPTION OF THE DRAWINGS

A general architecture that implements the various features of the invention will now be described with reference to the drawings. The drawings and the associated descriptions are provided to illustrate embodiments of the invention and not limited the scope of the invention.

FIG. 1 is an exemplary block diagram showing a configuration of a television receiver being used as an electronic apparatus equipped with a power controller according to an embodiment of the present invention;

FIG. 2 is an exemplary block diagram showing a configuration of a system formed of respective modules for executing a power supply control process according to the embodiment;

FIG. 3 is an exemplary sequence diagram illustrating an operation for turning on a power supply having a predetermined voltage in the power supply control process;

FIG. 4 is an exemplary sequence diagram illustrating an operation for turning off a power supply having a predetermined voltage in the power supply control process;

FIG. 5 is an exemplary view showing a configuration of a system formed of respective modules for executing a power control process according to a modified embodiment of the embodiment; and

FIG. 6 is an exemplary sequence diagram illustrating an operation for turning off the predetermined voltage power in the power supply control process according to the modified embodiment.

### DETAILED DESCRIPTION

Various embodiments according to the invention will be described hereinafter with reference to the accompanying drawings.

In general, according to one embodiment, a power controller for controlling a power supply having a predetermined voltage, generated based on a power supplied from an external power source and supplied to a signal processor, includes: a receiver configured to receive a signal for switching an ON/OFF state of the power supply from a remote controller, a controller configured to control the ON/OFF state of the power supply depending on the signal received by the receiver, and an determining module configured to determine whether the signal received by the receiver is a signal for switching the power supply from the OFF state to the ON state or a signal for switching the power supply from the ON state to the OFF state, based on information regarding the ON/OFF control of the power supply using the controller. The controller is configured to control to turn off the power supply, depending on a response to a notification of a result of the determination from the signal processor, when the determining module determines that the signal received by the receiver is the signal for switching the power supply from the ON state to the OFF state. Further, the receiver, the controller and the determining module are configured to operate by a rechargeable battery charged based on the power supply, while the power supply is in an ON state, when the power supply is turned off.

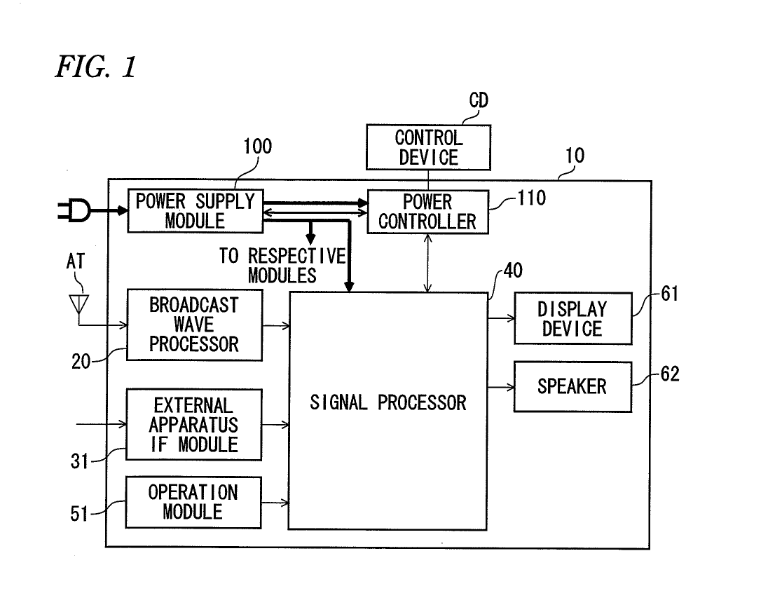

FIG. 1 is an exemplary block diagram showing the configuration of a television receiver 10 being used as an electronic apparatus equipped with a power controller according to the embodiment of the present invention.

The television receiver 10 according to the embodiment includes a broadcast wave processor 20, an external apparatus IF module 31, a signal processor 40, an operation module 51, a display device 61, a speaker 62, a power supply module 100, a power controller 110, etc. Furthermore, an antenna ANT is connected to the broadcast wave processor 20, and the power supply module 100 is connected to a household outlet or the like. Moreover, the power controller 110 exchanges information with a control device CD. For example, the control device CD is a remote controller, such as an infrared remote controller or a wireless communication apparatus.

The television receiver 10 operates based on a power supplied from a household outlet or the like connected to the power supply module 100. Furthermore, the television receiver 10 executes a power supply control process for switching an ON/OFF state of the power supply to be supplied to almost all the modules of the television receiver 10 based on information regarding the present ON/OFF state of the power supply depending on a signal that is input from the control device CD to turn on/off the power supply.

The power supply module 100 executes voltage conversion processes, such as AC/DC conversion and DC/DC conversion, based on the power supplied from a household outlet or the like to generate a predetermined voltage power. Then, the power module 100 supplies the generated predetermined voltage power to almost all the modules of the television receiver 10 including the signal processor 40. Furthermore, the power supply module 100 switches an ON/OFF state of the power supply having the predetermined voltage based on a control signal input from the power controller 110 to execute a power supply control process. Moreover, the power supply module 100 charges a rechargeable battery based on the power supply having the predetermined voltage, thereby generating a charged power to be used as a power supply. When the power supply module 100 turns off the power supply having the predetermined voltage by means of the power supply control process, the power supply module 100 supplies the generated charged power to the power controller 110.

The power controller 110 exchanges information with the control device CD and communicates with the signal processor 40 according to this information. In addition, the power controller 110 outputs control signals for switching an ON/OFF state of the power supply having the predetermined voltage to the power supply module 100 based on the information input from the control device CD, thereby executing the power supply control process. Besides, when the power supply module 100 turns off the power supply having the predetermined voltage, the power controller 110 operates on the charged power supplied from the power supply module 100. When the power supply module 100 turns on the power supply having the predetermined voltage, the power controller 110 operates on the predetermined voltage power supplied from the power supply module 100.

Almost all the modules to be described hereafter operate on the predetermined voltage power supplied from the power supply module 100. For this reason, when the power supply module 100 turns off the power supply having the predetermined voltage by means of the power supply control process, almost all the modules to be described hereafter do not operate.

The broadcast wave processor 20 has a tuner and a decoder adapted for terrestrial or satellite digital and analog broadcast waves received using the antenna ANT. The broadcast wave processor 20 obtains a signal received using the antenna ANT, performs a specific channel selection process and demodulation/decoding processes depending on this obtained signal, and outputs signals including video/audio information on a program, information relating to the program, etc. to the signal processor 40. The information relating to the program includes the channel number of the program, the broadcast wave for the program, the name of the broadcast station for the program, the title of the program, the genre of the program, etc.

The external apparatus IF module 31 is used for connection to, for example, external apparatuses of the television receiver 10 and recording media, such as an external HDD and a memory card, via the connectors thereof conforming to various standards, such as the HDMI (registered trade name) standard, the USB standard and the IEEE 1394 standard. In addition, the external apparatus IF module 31 obtains signals including the video/audio information on a plurality of programs and information relating to the programs provided from the external apparatuses, recording media, etc. connected thereto and outputs the signals to the signal processor 40.

The operation module 51 receives operation input information for operating the television receiver 10 and outputs the information to the signal processor 40.

The signal processor 40 executes various processes, such as a decompression process for compressed data, and an information extraction process for creating a program schedule, for the information input from the broadcast wave processor 20, the external apparatus IF module 31, etc. based on the information, such as the operation input information, from the operation module 51 and the power controller 110. The signal processor 40 executes various processes, such as MPEG encoding/decoding arithmetic processes and video/audio signal separation processes, for the obtained information, and then outputs a video signal to the display device 61 and an audio signal to the speaker 62. Furthermore, the signal processor 40 is equipped with a CPU or a microcomputer (not shown) serving as a controller and controls the execution of a plurality of processes using respective modules provided for the signal processor 40 itself and respective modules connected to the signal processor 40.

In the embodiment, the signal processor 40 communicates with the power controller 110 depending on the operation input information exchanged between the power controller 110 and the control device CD and executes various processes corresponding to the operation input information from the control device CD. More specifically, the signal processor 40 communicates with the power controller 110 with respect to information for turning off the power supply to the television receiver 10 and executes a predetermined process for turning off the power supply. In addition, the signal processor 40 operates on the predetermined voltage power supplied from the power supply module 100 as described above.

The display device 61 is a display module for displaying the video signal input from the signal processor 40. For example, the display device 61 is a thin display, such as a liquid crystal display (hereafter also referred to as an LCD) or a PDP (plasma display panel).

The speaker 62 outputs the audio signal input from the signal processor 40.

In the embodiment, the television receiver is taken as an example of an electronic apparatus equipped with the power controller to which the configuration according to the present invention is applied. However, an electronic apparatus, such as an HDD recorder, a DVD recorder, a personal computer or a mobile terminal, having a structure similar to that of the electronic apparatus according to the embodiment may also be taken as an example of the electronic apparatus. Furthermore, a set top box serving as an electronic apparatus for receiving not only television broadcast and satellite broadcast but also radio broadcast, cable broadcast using the Internet, etc. and for outputting video signals may also be taken as an example of the electronic apparatus.

With this configuration, the respective modules of the television receiver 10 according to the embodiment of the present invention operate on the predetermined voltage power and the charged power supplied via the power supply module 100. Moreover, the predetermined voltage power or the charged power is supplied to specific modules of the television receiver 10, and the specific modules controls an ON/OFF state of the power supply having the predetermined voltage to be supplied to almost all the modules. In particular, when control is executed to turn off the power supply having the predetermined voltage, the specific modules operate on the charged power. For this reason, standby power can be reduced with a simple configuration.

In addition, these processes are executed mainly using the power controller 110 based on the power supplied via the power supply module 100.

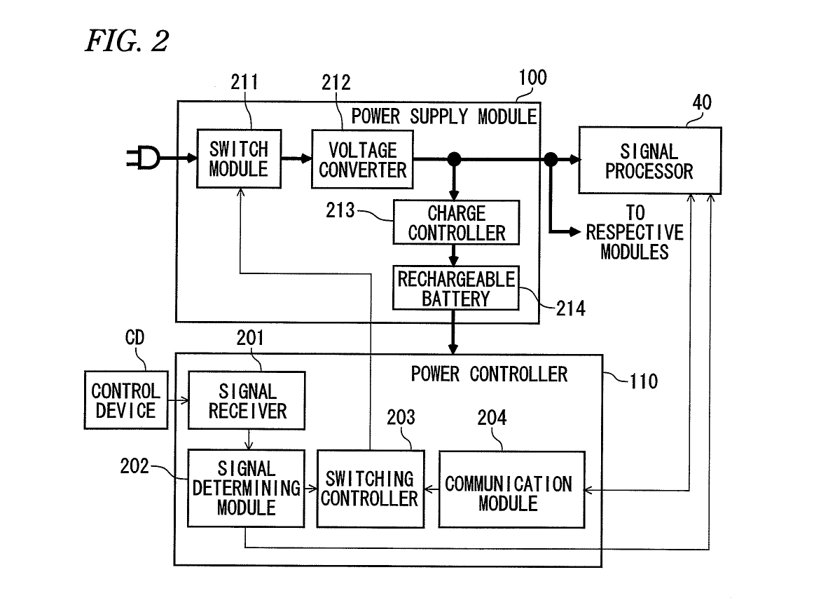

Next, respective modules provided for the power supply module 100 and the power controller 110 described referring to FIG. 1 to execute the power supply control process will be described below referring to FIG. 2.

FIG. 2 is an exemplary view showing the configuration of a system formed of the respective modules for executing the power supply control process according to the embodiment.

As described above, the power supply control process is a process in which the power controller 110 outputs a control signal based on information from the control device CD and the power supply module 100 switches an ON/OFF state of the power supply having the predetermined voltage based on this output control signal.

The power supply module 100 according to the embodiment is equipped with a switching module 211, a voltage converter 212, a charge controller 213, a rechargeable battery 214, etc. In addition, the power controller 110 according to the embodiment is equipped with a signal receiver 201, a signal determining module 202, a switching controller 203, a communication module 204, etc.

First, the respective modules provided for the power supply module 100 will be described below.

The switching module 211 is formed of a switch for opening/closing a power supply path for supplying the power to the signal processor 40. Based on information input from the switching controller 203, the switching module 211 opens/closes the power supply path, thereby turning on/off the power supply. Furthermore, the switching mode 211 is provided for a path closer to the external power source than the voltage converter 212 among paths for supplying the power from a household outlet or the like. Namely, the switching module 211 is provided for a path between the external power source and the voltage converter 212. For example, a relay and a mechanical switch can be used as the switching module 211. However, in the embodiment, a configuration in which a relay is used as the switching module 211 is taken as an example and described below.

The voltage converter 212 subjects the power supplied via the switching module 211 to voltage conversion processes, such as AC/DC conversion and DC/DC conversion, to generate the predetermined voltage power and supplies the generated predetermined voltage power to the charge controller 213. In addition, the voltage converter 212 also supplies the predetermined voltage power to the respective modules of the television receiver 10.

When the power supply having the predetermined voltage is turned on, the charge controller 213 charges the rechargeable battery 214 based on the power supply having the predetermined voltage supplied from the voltage converter 212 to generate a charged power (the rechargeable battery 214). However, even if the power supply having the predetermined voltage is turned on, when the rechargeable battery 214 is fully charged, the charge controller 213 stops the execution of the charging process and operates to supply the predetermined voltage power. The charge controller 213 also stops the execution of the charging process when the power supply having the predetermined voltage is turned off.

The rechargeable battery 214 is a charged power that is charged by the charging process executed using the charge controller 213 when the power supply having the predetermined voltage is turned on and that is used as a power supply when the power supply having the predetermined voltage is turned off. In other words, when the power supply having the predetermined voltage is turned off, the rechargeable battery 214 serves as a charged power and the charged power is supplied to the respective modules of the power controller 110. Furthermore, when the power supply having the predetermined voltage is turned on, the rechargeable battery 214 is not used as a power but is charged by the charging process under the control of the charge controller 213. Furthermore, the charging is stopped when the rechargeable battery 214 is fully charged. For example, an electric double layer capacitor having a predetermined capacitance can be used as the rechargeable battery 214.

Next, the respective modules provided for the power controller 110 will be described below.

The signal receiver 201 receives a signal relating to operation input for operating the television receiver 10 and transmitted from the control device CD. Then, the signal receiver 201 subjects the received signal to a predetermined process to obtain information, and outputs the information to the signal determining module 202. For example, when the control device CD is an infrared remote controller, the signal receiver 201 subjects an infrared signal transmitted from the control device CD to photoelectric conversion to obtain information, and outputs the information obtained by the conversion to the signal determining module 202. In particular, in a general-purpose infrared remote controller, the operation key thereof for turning on/off the power supply is generally a single key. The power supply is controlled so as to be turned on/off alternately each time this operation key is pressed. Hence, the signal for turning on/off the power supply, transmitted from the infrared remote controller, is a single signal. Furthermore, the signal receiver 201 may transmit, for example, information indicating the state of the television receiver 10, to the control device CD.

The signal determining module 202 determines the information input from the signal receiver 201 and outputs the information to the signal processor 40. However, when the information input from the signal receiver 201 is determined as specific information as the result of the determination, the signal determining module 202 checks the control state of the switching controller 203. Then, the signal determining module 202 outputs specific control information corresponding to the result of the determination and the result of the checking to the switching controller 203 or the signal processor 40. More specifically, the output is performed when the input information is information for controlling an ON/OFF state of the power supply to the television receiver 10. For example, the signal for turning on/off the power supply, transmitted from the control device CD, such as an infrared remote controller, is generally a single signal. At the time, the signal determining module 202 checks whether the control state of the switching controller 203 is open or closed and outputs control information for opening/closing the switching module 211 (for turning on/off the power supply) corresponding to the result of the determination or the result of the checking to the switching controller 203 or the signal processor 40.

Based on the control information input from the signal determining module 202 or the communication module 204, the switching controller 203 outputs switching information for controlling to open/close the power supply path to the switching module 211. In addition, depending on the result of the checking from the signal determining module 202, the switching controller 203 responds by indicating whether the switching information output to the switching module 211 indicates open or closed.

When the communication module 204 communicates with a controller (not shown) provided for the signal processor 40 and receives control information for controlling to open the switching module 211 (to turn off the power supply), the communication module 204 outputs this control information to the switching controller 203.

In other words, based on the switching information input from the switching controller 203 provided for the power controller 110 having received a signal from the control device CD, the switching module 211 provided for the power supply module 100 switches an ON/OFF state of the power supply having the predetermined voltage. When the switching controller 203 turns on the power supply having the predetermined voltage, charging is executed for the rechargeable battery 214 serving as a charged power. When the switching controller 203 turns off the power supply having the predetermined voltage, the rechargeable battery 214 serving as a charged power supplies the charged power to the respective modules of the power controller 110.

With this system configuration, the power controller 110 according to the embodiment of the present invention is configured so as to serve as a power controller for the power supply module 100. Furthermore, the predetermined voltage power or the charged power is supplied to the power controller 110, and the power controller 110 executes the power supply control process for the respective power supplied from the power supply module 100. In particular, when the power supply having the predetermined voltage is controlled so as to be turned off, the power controller 110 operates on the charged power. As a result, standby power can be reduced with this simple configuration.

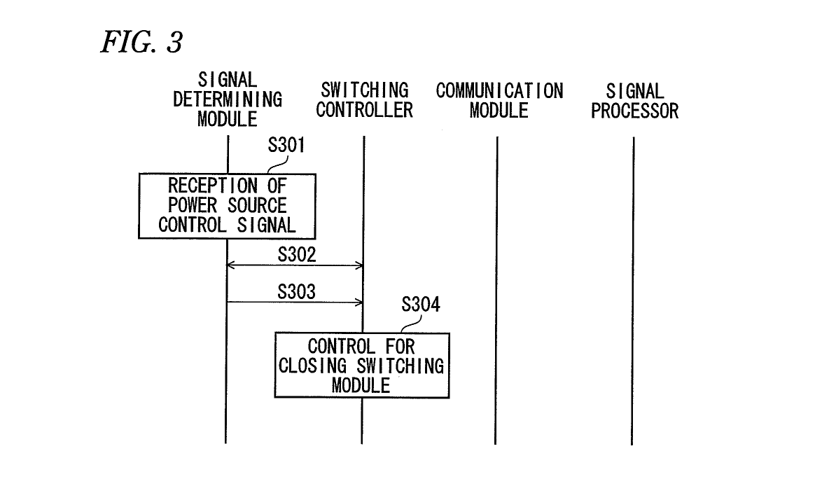

Next, in the power supply control process executed using the respective modules described referring to FIG. 2, an operation for turning on the predetermined voltage power will be described below referring to FIG. 3.

FIG. 3 is an exemplary sequence diagram illustrating the operation for turning on the predetermined voltage power in the power supply control process.

First, the signal determining module 202 determines that the information output from the signal receiver 201 depending on a signal transmitted from the control device CD is the information for controlling an ON/OFF state of the power supply to the television receiver 10 (at step S301). In addition, the signal determining module 202 checks the control state of the switching controller 203 and determines that the control state of the switching controller 203 is open at present (the power supply is OFF) (at step S302). Then, the signal determining module 202 outputs the control information for controlling to close the switching module 211 (to turn on the power supply) to the switching controller 203 (at step S303). Upon receiving the control information, the switching controller 203 outputs the switching information for controlling to close the power supply path (to turn on the power supply) to the switching module 211. Then, based on the switching information, the switching module 211 closes the power supply path, thereby turning on the power supply having the predetermined voltage (at step S304).

In other words, in the operation for turning on the predetermined voltage power in the power supply control process, after determining that the present state of the power supply is OFF, the signal determining module 202 directly outputs control information to the switching controller 203 so that the power supply is turned on.

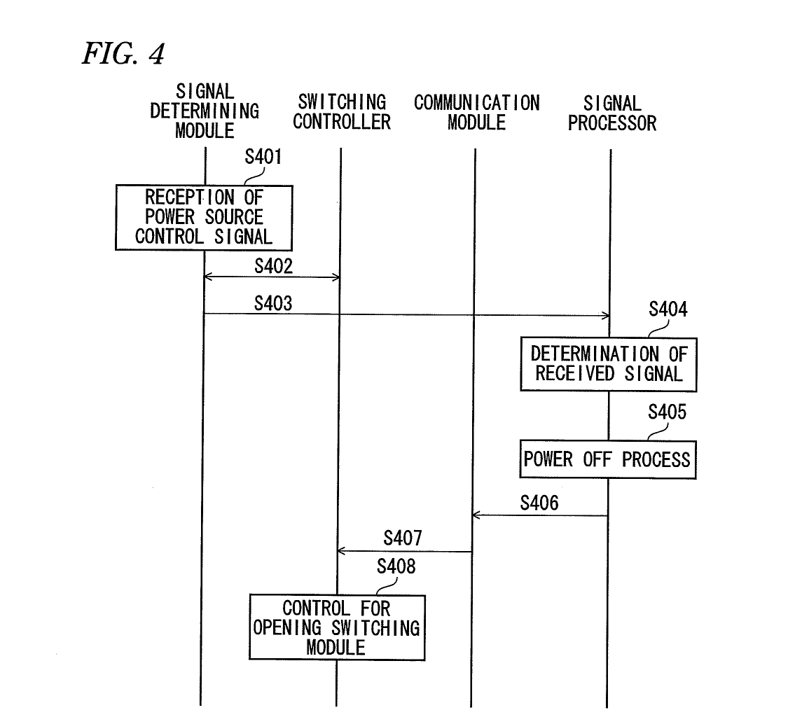

Next, in the power supply control process executed by the respective modules of the system configuration described referring to FIG. 2, an operation for turning off the predetermined voltage power will be described below referring to FIG. 4.

FIG. 4 is an exemplary sequence diagram illustrating the operation for turning off the predetermined voltage power in the power supply control process.

First, the signal determining module 202 determines that the information output from the signal receiver 201 depending on a signal transmitted from the control device CD is the information for controlling an ON/OFF state of the power supply to the television receiver 10 (at step S401). In addition, the signal determining module 202 checks the control state of the switching controller 203 and determines that the control state of the switching controller 203 is closed at present (the power supply is turned on) (at step S402). Then, the signal determining module 202 outputs the control information for controlling to open the switching module 211 (to turn off the power supply) to the signal processor 40 (at step S403).

Next, the signal processor 40 determines that the control information input from the signal determining module 202 provided for the power controller 110 is the information for controlling to open the power supply path (to turn off the power supply) (at step S404). In addition, the signal processor 40 controls to cause the respective modules provided for the television receiver 10 and connected to the signal processor 40 to execute predetermined processes associated with turning off the power supply (at step S405). Furthermore, after the predetermined processes associated with turning off the power supply are executed, the signal processor 40 communicates with the communication module 204 provided for the power controller 110 with respect to the control information for controlling to open the switching module 211 (to turn off the power supply) (at step S406).

At this time, the communication module 204 outputs the control information for controlling to open the switching module 211 (to turn off the power supply) to the switching controller 203 (at step S407). Then, the switching controller 203 outputs the switching information for controlling to open the power supply path (to turn off the power supply) to the switching module 211. The switching module 211 opens the power supply path according to the switching information, thereby turning off the power supply having the predetermined voltage (at step S408). When the power supply having the predetermined voltage is turned off, the charged power from the rechargeable battery 214 is supplied to the power controller 110, and the power controller 110 can operate.

In other words, in the operation for turning off the predetermined voltage power in the power supply control process, after determining that the present state of the power supply is ON, the signal determining module 202 outputs the information for turning off the power supply to the signal processor 40. Furthermore, the communication module 204 communicates with the signal processor 40 to inform that this process is completed and outputs control information to the switching controller 203 so that the power supply is turned off.

As described above, the power supply control process is executed wherein the OFF state of the power supply in which the power controller 110 operates on the charged power and the ON state of the power supply in which almost all the modules of the television receiver 10 operate are switched according to the sequences described referring to FIGS. 3 and 4.

### Modified Embodiment

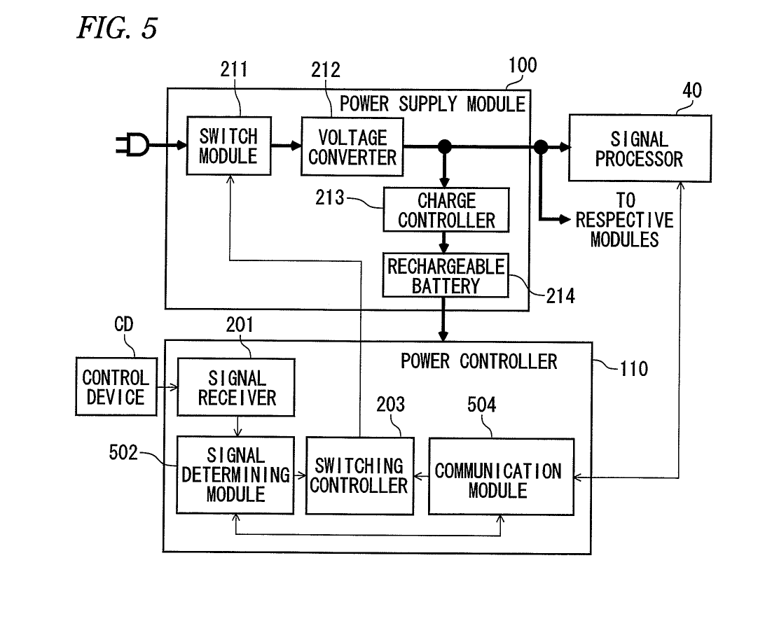

Next, respective modules provided for the power supply module 100 and the power controller 110 described referring to FIG. 1 to execute a power supply control process according to a modified embodiment will be described below referring to FIG. 5.

FIG. 5 is an exemplary view showing the configuration of a system formed of the respective modules for executing the power control process according to the modified embodiment of the embodiment of the present invention.

The system configuration according to the modified embodiment is almost the same as the system configuration shown in FIG. 2 but is different therefrom in that only a communication module 504 among the modules provided for the power controller 110 exchanges information with the signal processor 40. Hereafter, the same reference codes as those used in the system configuration view of FIG. 2 are assigned to modules similar to those shown in the system configuration view of FIG. 2. In addition, the descriptions of the similar modules are omitted or simplified, and main differences are described in detail.

The power supply module 100 according to the modified embodiment is equipped with the switching module 211, the voltage converter 212, the charge controller 213, the rechargeable battery 214, etc. In addition, the power controller 110 according to the modified embodiment is equipped with the signal receiver 201, a signal determining module 502, the switching controller 203, the communication module 504, etc.

The respective modules provided for the power supply module 100 are similar to the respective modules described referring to FIG. 2.

In other words, the predetermined voltage power generated by subjecting the power supplied via the switching module 211 for opening/closing the power supply path to predetermined voltage conversion processes using the voltage converter 212 is supplied to the respective modules of the charge controller 213 and the television receiver 10. Furthermore, based on the power supply having the predetermined voltage, the charge controller 213 generates the charged power (the rechargeable battery 214) by executing the charging process for charging the rechargeable battery 214 and supplies the charged power to the power controller 110.

Next, the respective modules provided for the power controller 110 will be described below.

Since the signal receiver 201 and the switching controller 203 are respectively similar to those shown in FIG. 2, the descriptions thereof are omitted.

The signal determining module 502 is different from the signal determining module 202 shown in FIG. 2 in that the signal determining module 502 does not output determined information to the signal processor 40 provided outside the power controller 110 but outputs to the communication module 504 provided for the power controller 110. For this reason, specifically speaking, the signal determining module 502 determines information input from the signal receiver 201 and outputs the information to the communication module 504. Furthermore, when the input information is determined as the information for controlling an ON/OFF state of the power supply to the television receiver 10, the signal determining module 502 checks whether the control state of the switching controller 203 is open or closed. Then, the signal determining module 502 outputs the control information for opening/closing the switching module 211 (for turning on/off the power supply) corresponding to the result of the determination and the result of the checking to the switching controller 203 or the communication module 504.

The communication module 504 is different from the communication module 204 shown in FIG. 2 in that the information regarding the result of the determination performed using the signal determining module 502 is input thereto. Hence, the information regarding the result of the determination performed using the signal determining module 502 is input to the communication module 504, and the communication module 504 communicates with the controller (not shown) provided for the signal processor 40 with respect to the input information. Furthermore, when the communication module 504 communicates with the signal processor 40 and receives control information for controlling to open the switching module 211 (to turn off the power supply), the communication module 504 outputs this control information to the switching controller 203.

The power controller 110 according to the embodiment of the present invention is configured so as to serve as a power controller for the power supply module 100 even in the power supply control process according to the modified embodiment executed using the system configuration described above. In addition, the predetermined voltage power or the charged power is supplied to the power controller 110, and the power controller 110 controls an ON/OFF state of the various powers supplied from the power supply module 100. In particular, when control is executed to turn off the power supply having the predetermined voltage, the power controller 110 operates on the charged power. For this reason, standby power can be reduced with a simple configuration.

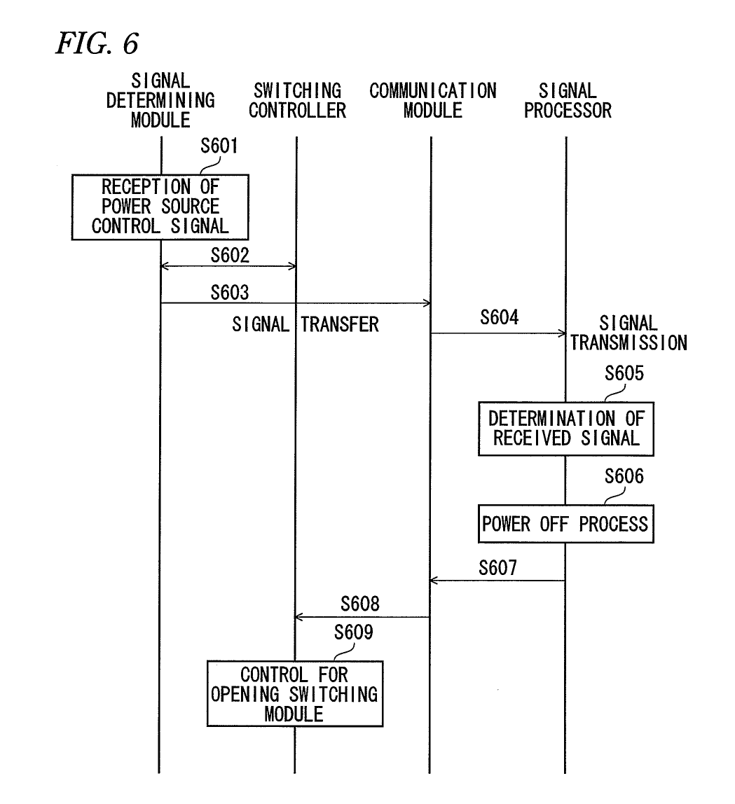

Next, in the power supply control process according to the modified embodiment executed by the respective modules of the system configuration described referring to FIG. 5, an operation for turning off the predetermined voltage power will be described below referring to FIG. 6.

FIG. 6 is an exemplary sequence diagram illustrating the operation for turning off the predetermined voltage power in the power supply control process according to the modified embodiment.

The sequence diagram illustrating the operation for turning off the predetermined voltage power according to the modified embodiment is nearly similar to the sequence diagram shown in FIG. 4, but is different therefrom in that the control information for turning off the power supply is output from the signal determining module 502 to the signal processor 40 via the communication module 504. Hereafter, the descriptions of portions similar to those shown in the sequence diagram of FIG. 4 are simplified, and main differences are described in detail.

First, the signal determining module 502 determines that the information input from the signal receiver 201 is the information for controlling an ON/OFF state of the power supply (at step S601), and checks the control state of the switching controller 203 and determines that the power supply is turned on (at step S602). Furthermore, the signal determining module 502 outputs the control information for controlling to open the switching module 211 (to turn off the power supply) to the communication module 504 (at step S603).

Then, the communication module 504 to which the control information is input communicates with the controller (not shown) provided for the signal processor 40 and outputs the control information to the signal processor (at step S604). Furthermore, the signal processor 40 determines that the control information input from the communication module 504 is the information for turning off the power supply (at step S605) and controls to cause the respective modules connected to the signal processor 40 to execute a plurality of processes associated with turning off the power (at step S606). Furthermore, after the plurality of processes associated with turning off the power supply are executed, the signal processor 40 communicates with the communication module 504 with respect to the control information for turning off the power supply (at step S607).

At this time, the communication module 504 outputs the control information for turning off the power supply to the switching controller 203 (at step S608). Then, the switching controller 203 outputs the switching information for controlling to open the power supply path (to turn off the power supply) to the switching module 211. The switching module 211 turns off the power supply having the predetermined voltage according to the switching information (at step S609). When the power supply having the predetermined voltage is turned off, the charged power from the rechargeable battery 214 is supplied to the power controller 110, and the power controller 110 can operate.

In other words, in the operation for turning off the predetermined voltage power in the power supply control process according to the modified embodiment, after determining that the present state of the power supply is turned on, the signal determining module 502 outputs the information for turning off the power supply to the signal processor 40 via the communication module 504. Furthermore, the communication module 504 communicates with the signal processor 40 to inform that this process is completed and outputs control information to the switching controller 203 so that the power supply is turned off.

As described above, the power supply control process according to the modified embodiment is executed wherein the ON state of the power supply and the OFF state of the power supply in which the power controller 110 operates on the charged power are switched according to the sequence described referring to FIG. 6.

As described above, according to the embodiment, the television receiver 10 has the ON state in which the predetermined voltage power generated from the power supplied from a household outlet or the like is supplied and the OFF state in which the predetermined voltage power is not supplied but the charged power based on the predetermined voltage power is supplied to the power controller 110, as the states of the power supply. Furthermore, the power supply control process for switching the OFF/ON state of the power supply is executed mainly using the power controller 110 according to the predetermined sequences. Moreover, in the OFF state of the power supply, the power controller 110 operates on the rechargeable battery 214 serving as the charged power. For this reason, standby power can be reduced with a simple configuration.

Furthermore, the invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A power controller for controlling a power supply having a predetermined voltage, generated based on a power supplied from an external power source and supplied to a signal processor, comprising:
a receiver configured to receive a signal for switching an ON state and an OFF state of the power supply from a remote controller,
a controller configured to control the ON state and the OFF state of the power supply depending on the received signal, and
an determining module configured to determine whether the received signal is a signal for switching the power supply from the OFF state to the ON state or a signal for switching the power supply from the ON state to the OFF state, based on information regarding the ON and OFF control of the power supply using the controller, wherein
the controller is configured to control to turn off the power supply, depending on a response to a notification of a result of the determination from the signal processor, when the determining module determines that the received signal is the signal for switching the power supply from the ON state to the OFF state, and
the receiver, the controller and the determining module are configured to operate by a rechargeable battery if the power supply is controlled to turn off, the rechargeable battery being charged by the power supply while the power supply is in an ON state.

2. The power controller of claim 1, further comprising:
a communication module configured to communicate with the signal processor, wherein
the communication module is configured to communicate regarding a notification of at least one of a result of determination and a response from the signal processor, when the determining module determines that the received signal is the signal for switching the power supply from the ON state to the OFF state.

3. The power controller of claim 2, wherein
the controller is configured to control the ON state and the OFF state of the power supply by opening and closing a power supply path in which predetermined voltage conversion is not yet executed for the power supply, the power supply path being close to an external power source.

4. An electronic apparatus comprising:
a signal processor, and
a power controller for controlling a power supply having a predetermined voltage, generated based on a power supplied from an external power source and supplied to the signal processor, comprising:
a receiver configured to receive a signal for switching an ON state and an OFF state of the power supply from a remote controller,
a controller configured to control the ON state and the OFF state of the power supply depending on the received signal, and
an determining module configured to determine whether the received signal is a signal for switching the power supply from the OFF state to the ON state or a signal for switching the power supply from the ON state to the OFF state, based on information regarding the ON and OFF control of the power supply using the controller, wherein
the controller is configured to control to turn off the power supply, depending on a response to a notification of a result of the determination from the signal processor, when the determining module determines that the received signal is the signal for switching the power supply from the ON state to the OFF state, and
the receiver, the controller and the determining module are configured to operate by a rechargeable battery if the power supply is turned off, the rechargeable battery being charged by the power supply while the power supply is in an ON state.

5. A power control method for controlling a power supply having a predetermined voltage, generated based on a power supplied from an external power source and supplied to a signal processor, by a power controller for controlling a power supply having a predetermined voltage, generated based on a power supplied from an external power source and supplied to a signal processor,
the method comprising:
receiving a signal for switching an ON state and an OFF state of the power supply from a remote controller,
controlling the ON state and the OFF state of the power supply depending on the received signal, and
determining whether the received signal is a signal for switching the power supply from the OFF state to the ON state or a signal for switching the power supply from the ON state to the OFF state, based on information regarding the ON and OFF control of the power supply, wherein
the power supply is turned off depending on a response to a notification of a result of determination from the signal processor, when the received signal is determined as the signal for switching the power supply from the ON state to the OFF state, and
the power controller is powered to perform the receiving, the controlling and the determining by supplying a rechargeable battery if the power supply is in an OFF state, the rechargeable battery being charged by the power supply while the power supply is in an ON state.
